(19) United States
(12) Patent Application Publication
(10) Pub. No.: US 2015/0086178 A1
(43) Pub. Date: Mar. 26, 2015

(54) METHODS, SYSTEMS, AND COMPUTER READABLE MEDIA FOR DISPLAYING CUSTOM-TAILORED MUSIC VIDEO CONTENT

(71) Applicants: Charles Ray, Toball, TX (US); Cody Guinn, Magnolia, TX (US); Cory Guinn, Tomball, TX (US); Mickael Zibi, Tomball, TX (US)

(72) Inventors: Charles Ray, Toball, TX (US); Cody Guinn, Magnolia, TX (US); Cory Guinn, Tomball, TX (US); Mickael Zibi, Tomball, TX (US)

(21) Appl. No.: 14/032,219

(22) Filed: Sep. 20, 2013

(51) Int. Cl. G11B 27/10; G11B 27/28; G11B 27/00; G11B 27/34

(52) U.S. Cl. CPC G11B 27/102; G11B 27/34; G11B 27/28; G11B 27/002
USPC 386/241

(57) ABSTRACT

Applicants have created systems, methods, and computer readable media for displaying custom-tailored music video content. The method can include the step of providing a first selection of the media content and the step of outputting a first portion of first media data if first media data is selected or a first portion of second media data if second media data is selected. The method can further include the step of providing a second selection of the media content and the step of outputting a selected portion of the media content among second and third portions of the first and second media data. Through the inventions described herein, an end-user can enjoy custom-tailored music video content through a process of dynamically choosing which music video characters and sub-plots to follow through to their various alternative endings.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to systems, methods, and computer readable media for displaying custom-tailored music video content. In one of the aspects, the invention specifically relates to system, methods, and computer readable media for permitting an end-user to dynamically choose the outcome of a music video. In further aspects, the inventions relate to systems, methods, and computer readable media to provide an end-user with the opportunity to observe various characters and sub-plots of a music video in order reach a conclusion based on the end-user's specific choices throughout the music video.

2. Description of the Related Art

The inventions disclosed and taught herein are directed to improved systems, methods, and computer readable media for displaying custom-tailored music video content. Although these inventions can be used in numerous applications, the inventions will be disclosed in only a few of many applications for illustrative purposes.

Musical videos have been part of mainstream culture for decades. Specifically, music videos' popularity have surged from the 1980s with the advent of twenty-four hour music television programming stations such as MTV® and VH1®. Music videos from the earlier decades (e.g., the '80s and '90s) typically involved the integration of an artist's song with visual depictions throughout video. Often, these music videos lasted the length of the song and routinely comprised animation, acting, or non-narrative and/or abstract forms to enhance the listeners' experiences while enjoying the artist's track.

Recently, musical artists, such as rappers and the like, have pushed the art of music video to high-production value segments that involve complex plots with sub-plots centering around various characters that can often intertwine paths one or more times throughout the duration of the video. These high-production segments differ significantly from their antecedent forms in that they often require multiple film crews shooting across various locations to achieve the final product.

Because of the overall complexity of these longer-form music videos, it is often difficult to present to the viewer a continuous story involving a single character or a single subplot without intertwining additional characters and/or sub-plots into the video as it is observed. Moreover, a user may prefer to observe the story of a particular character over another after he began viewing the music video. Additionally, traditional music videos, even those longer-forms ones described above, prevent a user from switching between the story of one character to another at his discretion.

What is required, therefore, are systems, methods, and computer readable media that are capable—among other things—of (i) displaying custom-tailored music video content to permit a user to select which particular characters and sub-plots to follow throughout a music video and (ii) permitting a user to modify her choices throughout the music video to observe a selected outcome of the music video among two or more alternative endings. Accordingly, the inventions disclosed and taught herein are directed to systems, methods, and computer readable media that overcome the problems as set forth above.

### BRIEF SUMMARY OF THE INVENTION

Applicants have created systems, methods, and computer readable media for displaying custom-tailored music video content. The method can include the step of providing a first selection of the media content and the step of outputting a first portion of first media data if first media data is selected or a first portion of second media data if second media data is selected. The method can further include the step of providing a second selection of the media content and the step of outputting a selected portion of the media content among second and third portions of the first and second media data. Through the inventions described herein, an end-user can enjoy custom-tailored music video content through a process of dynamically choosing which music video characters and sub-plots to follow through to their various alternative endings.

The method can include providing a first selection of the media content that can include first media data and second media data and the step of outputting a first portion the first media data if the first media data is selected or a first portion of the second media data if the second media data is selected. The method can further include the step of providing a second selection of the media content, wherein the media content for selection can include second and third portions of the first media data and second and third portions of the second media data. The method can further include the step of outputting a selected portion of the media content among the second and third portions of the first and second media data.

Additionally, the method can include the step of providing at least one transition opportunity that can be provided before the step of providing a second selection of the media content begins. The at least one transition opportunity can provide an opportunity to output a portion of the second media data if the first portion of the first media data is being outputted or output a portion of the first media data if the first portion of the second media data is being outputted. Moreover, the step of providing a second selection can further include (i) providing a selection of the second and third portions of the first media data if the first media data is outputting at a point in time when providing a second selection of the media content step occurs or (ii) providing a selection of the second and third portions of second media data if the second media data is outputting at a point in time when providing a second selection of the media content step occurs.

The media content can include a music video that can include a plurality of alternative endings and the second and third portions of the first media data can include first and second alternative endings, respectively, among the plurality of alternative endings of the first media data. Moreover, the second and third portions of the second media data can include a first and second alternative ending, respectively, among the plurality of alternative endings of the second media data. Additionally, the first media data can include a first sub-plot of the music video that can include a first character and the second media data can include a second sub-plot of the music video that can include a second character. Finally, the step of providing at least one transition opportunity can be performed at a commonality point between the first and second sub-plots that can include a music video frame that can include both the first and second characters.

The system for displaying custom-tailored music video content can include a mobile device and a computer readable medium. The computer readable medium can be configured to store an application for displaying media content and the application can be adapted to execute instructions for displaying media content that can include performing a series of steps. The application can execute instructions for performing the step of providing a first selection of the media content that can include first media data and second media data and the step of outputting a first portion the first media data if the first media data is selected or a first portion of the second media data if the second media data is selected. The application can be adapted to execute instructions that can further include the step of providing a second selection of the media content, wherein the media content for selection can include second and third portions of the first media data and second and third portions of the second media data. The application can be adapted to execute instructions that can further include the step of outputting a selected portion of the media content among the second and third portions of the first and second media data.

Additionally, the application can be adapted to execute instructions that can include the step of providing at least one transition opportunity that can be provided before the step of providing a second selection of the media content begins. The at least one transition opportunity can provide an opportunity to output a portion of the second media data if the first portion of the first media data is being outputted or output a portion of the first media data if the first portion of the second media data is being outputted. Moreover, the step of providing a second selection can further include (i) providing a selection of the second and third portions of the first media data if the first media data is outputting at a point in time when providing a second selection of the media content step occurs or (ii) providing a selection of the second and third portions of second media data if the second media data is outputting at a point in time when providing a second selection of the media content step occurs.

The media content can include a music video that can include a plurality of alternative endings and the second and third portions of the first media data can include first and second alternative endings, respectively, among the plurality of alternative endings of the first media data. Moreover, the second and third portions of the second media data can include a first and second alternative ending, respectively, among the plurality of alternative endings of the second media data. Additionally, the first media data can include a first sub-plot of the music video that can include a first character and the second media data can include a second sub-plot of the music video that can include a second character. Finally, the step of providing at least one transition opportunity can be performed at a commonality point between the first and second sub-plots that can include a music video frame that can include both the first and second characters.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates a flow diagram depicting a first embodiment of exemplary steps for carrying out a method for displaying custom-tailored music video content.

FIG. 2A is a functional block diagram illustrating the flow diagram depicting the first embodiment of exemplary steps for carrying out a method for displaying custom-tailored music video content as illustrated in FIG. 1 with some element labels omitted for clarity.

FIG. 2B is a functional block diagram further illustrating the flow diagram depicting the first embodiment of exemplary steps for carrying out a method for displaying custom-tailored music video content as illustrated in FIG. 1 with some element labels omitted for clarity.

FIG. 2C is a timing diagram depicting a first embodiment of exemplary steps for carrying out a method in accordance with certain aspects of the inventions described herein.

FIG. 2D is a first embodiment of a functional block diagram illustrating an exemplary chosen path in accordance with certain aspects of the inventions described herein.

FIG. 2E is a second embodiment of a functional block diagram illustrating an exemplary chosen path in accordance with certain aspects of the inventions described herein.

FIG. 3 is an alternative embodiment of a functional block diagram in accordance with certain aspects of the inventions described herein.

FIG. 4 illustrates an embodiment of a computer readable medium configured to store an application for displaying custom-tailored music video content in accordance with certain aspects of the inventions described herein.

FIG. 5 illustrates an embodiment of a system for displaying custom-tailored music video content in accordance with certain aspects of the inventions described herein.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

Applicants have created systems, methods, and computer readable media for displaying custom-tailored music video content. The method can include the step of providing a first selection of the media content and the step of outputting a first portion of first media data if first media data is selected or a first portion of second media data if second media data is selected. The method can further include the step of providing a second selection of the media content and the step of outputting a selected portion of the media content among second and third portions of the first and second media data. Through the inventions described herein, an end-user can enjoy custom-tailored music video content through a process of dynamically choosing which music video characters and sub-plots to follow through to their various alternative endings.

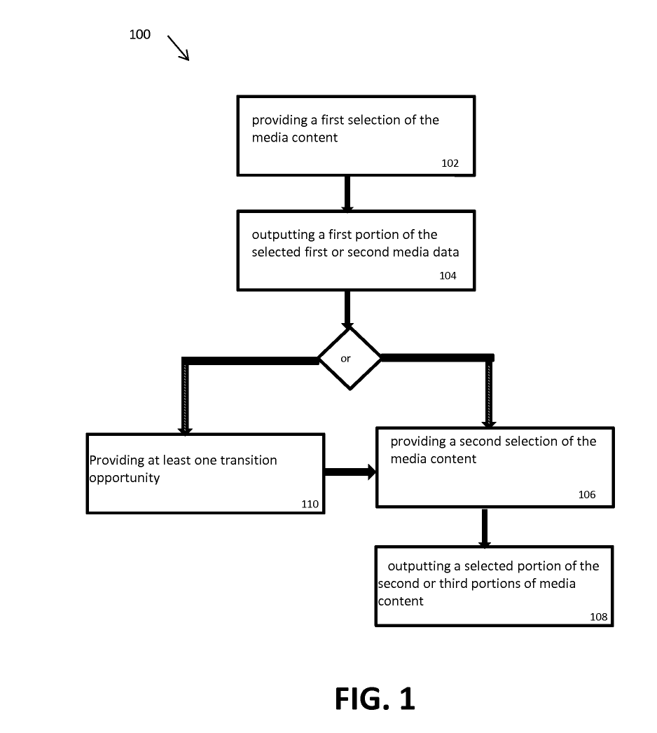

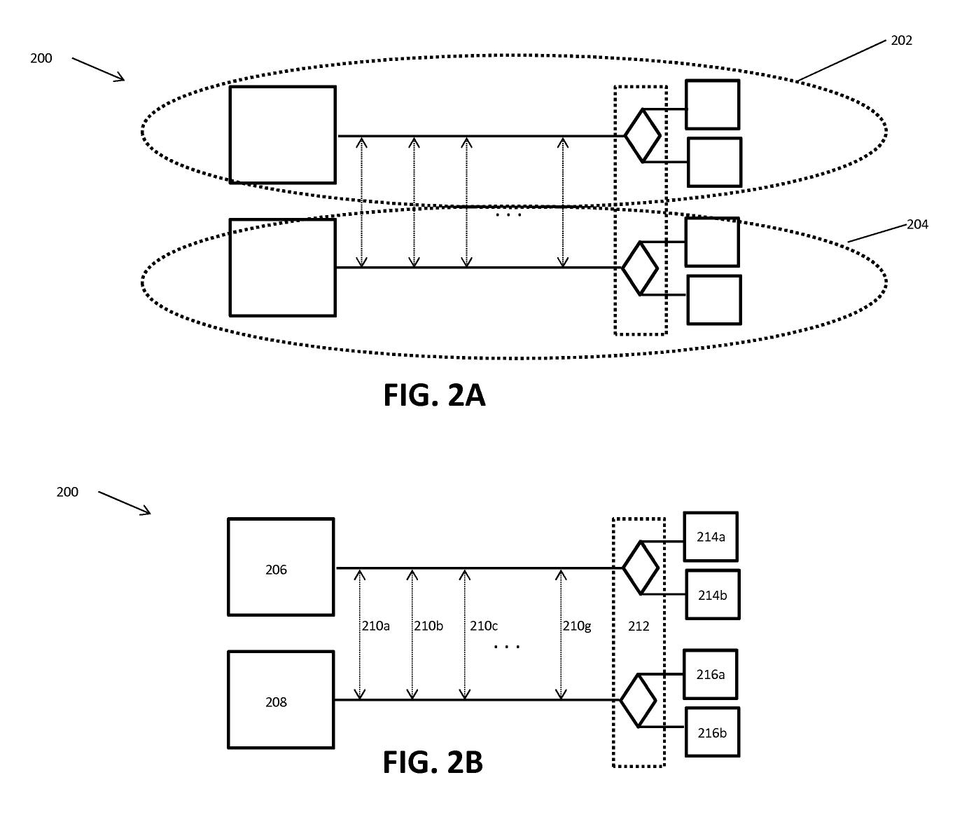

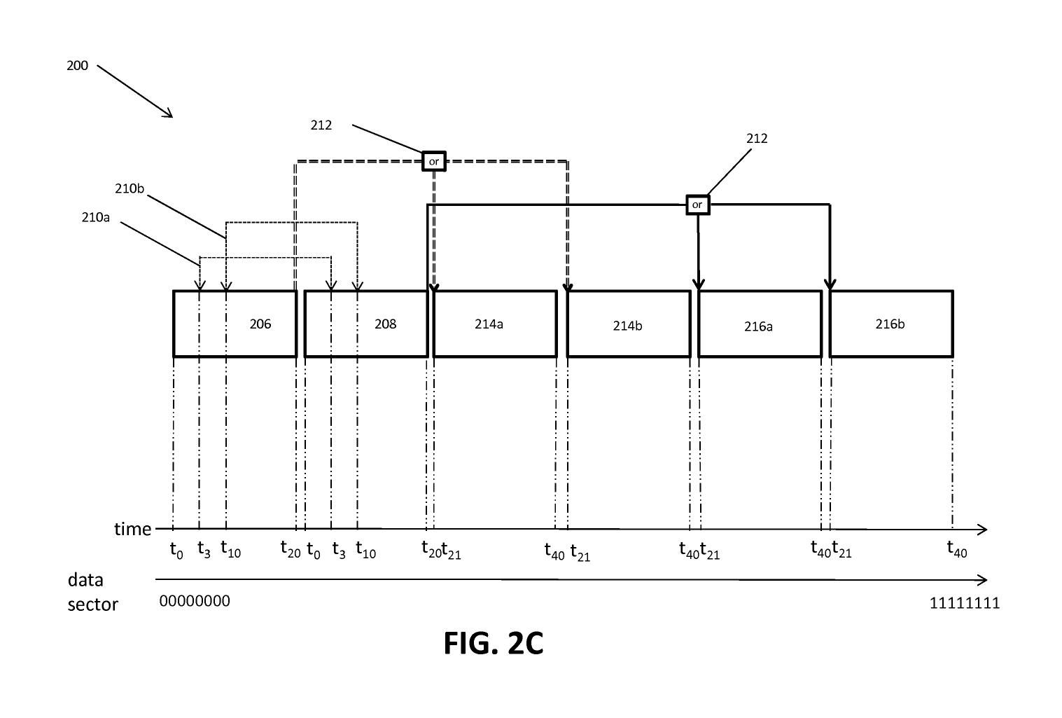

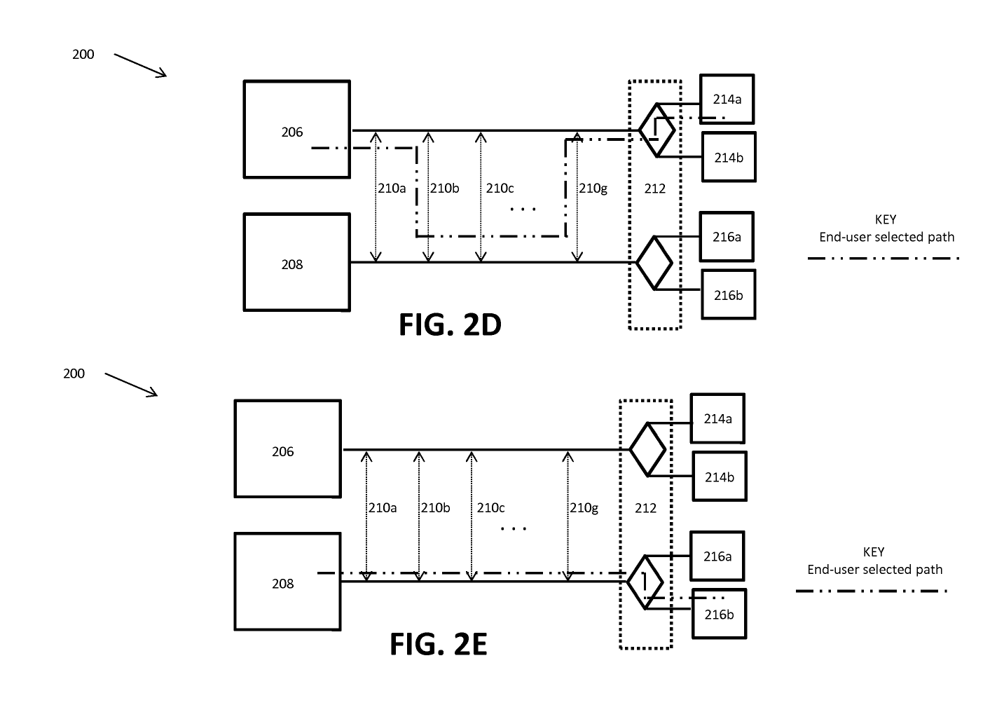

Turning now to the figures, FIG. 1 illustrates a flow diagram depicting a first embodiment of exemplary steps for carrying out a method for displaying custom-tailored music video content. FIG. 2A is a functional block diagram illustrating the flow diagram depicting the first embodiment of exemplary steps for carrying out a method for displaying custom-tailored music video content as illustrated in FIG. 1 with some element labels omitted for clarity. FIG. 2B is a functional block diagram further illustrating the flow diagram depicting the first embodiment of exemplary steps for carrying out a method for displaying custom-tailored music video content as illustrated in FIG. 1 with some element labels omitted for clarity. FIG. 2C is a timing diagram depicting a first embodiment of exemplary steps for carrying out a method in accordance with certain aspects of the inventions described herein. These figures will be described in conjunction with one another.

The method 100 for displaying custom-tailored music video content can include the step 102 of providing a first selection of the media content, wherein the media content comprises first media data and second media data and the step 104 of outputting a first portion the first media data if the first media data is selected or a first portion of the second media data if the second media data is selected. Furthermore, the method 100 can include the step 106 of providing a second selection of the media content, wherein the media content for selection comprises second and third portions of the first media data and second and third portions of the second media data and the step 108 of outputting a selected portion of the media content among the second and third portions of the first and second media data. The step 110 of providing at least one transition opportunity can be additionally performed, but typically before the step 106 of providing a second selection of the media content. The foregoing steps will be described in greater detail below with reference to FIGS. 2A, 2B, and 2C.

With specific reference with FIGS. 2A, 2B, and 2C, media content 200 can include first media data 202 (including first, second, and third portions of first media data (206, 214a, and 214b, respectively)) and second media data 204 (including first, second, and third portions of second media data (208, 216a, and 216b, respectively)).

Media content 200 can include one or more various forms of audio, video, and or audio/visual media content. For example, media content 200 can include audio data (such as, for example, an .mp3 file, a .wav file, or other digital or analog data that encodes one or more audio signals). As a specific example, media content 200 can include an audio track, such as a song, or other audible-based signal for producing sound.

Furthermore, media content 200 can include video data (such as, for example, a .mov file, .mpg file, or other digital or analog data that encodes one or more video signals). For example, media content 200 can include a visual track, such as a movie, or other visual-based signal for producing a still photograph and/or moving picture. Additionally, media content 200 can include a combination of audio-based and visual-based content and/or data, such as a movie, music video, or the like. With these hybrid-type audio/visual media, the audio and visual data can be stored and/or transmitted independently (e.g., as separate tracks) or contemporaneously (e.g., integrated) with the other.

First media data 202 and second media data 204 can include sub-sets of the data included within media content 200. That is, if media content 200 is a music video, first media data 202 can include the audio, visual, and/or audio-visual content relating to a particular portion of the music video and second media data 204 can include the audio, visual, and/or audio-visual content relating to another portion of the music video. Using the music video example above, first media data 202 can include a first sub-plot of the music video and second media data 204 can include a second sub-plot of the music video. In one example, the first sub-plot can comprise a first character and a second sub-plot can comprise a second character. Of course, additional sub-plots and/or characters can be included within the first and/or second media data (202, 204, respectively), as well.

Continuing with the example of two sub-plots and two characters described above within the context of a music video, in this embodiment, each character could have a unique sub-plot and/or story independent of the other. Of course, there could be instances throughout each of the first and second media data (202, 204, respectively) where the sub-plots and/or characters intertwine and/or interact with one another. These commonality points between the first and second sub-plots will be described in greater detail below.

It is important to note that the first and second media data (202, 204, respectively) can include two sets of media that are adapted to occur in parallel with one another throughout time. In other words, if first media data 202 includes a twenty-minute video clip involving the story of a first character and sub-plot, the second media data 204 can include a twenty-minute video clip involving the story of a second character and sub-plot occurring throughout the same period of time as the first character. With this example, an end-user, by selecting which media data (202 or 204) to view, can follow and/or observe the story of one character and/or sub-plot in favor of the other. Of course, the end-user is able to view both characters and/or sub-plots at the commonality points in the media content 200 as discussed below.

Using the music video example above, these commonality points can comprise a video frame (e.g., snap-shot) comprising both the first and second characters. Alternatively, these commonality points can include a key point where there is a transition between scenes displayed for that particular portion. By electing to transition from the first media data to the second media data (or vise-versa) at one of these scene changes, the end-user can finish observing the scene of one character, and begin viewing the next scene for the second character.

First portion of first media data 206 and first portion of second media data 208 can include the beginning portion first media data 202 and second media data 204, respectively. Using the music video example above again, first portion of first media data 206 can include all portions of the first media data 202 except for the plurality of conclusions and/or endings associated with the first media data 202 and first portion of second media data 208 can include all portions of the second media data 204 except for the plurality of conclusions associated with the second media data 204. In other words, if first and second media data (202 and 204, respectively) are each twenty-minutes long, the first portions of each of these respective data can include portions that are less than twenty-minutes long. The remaining portions of the first and second media data (202 and 204, respectively) can include the final portions of each media data. These portions are defined as the second and third portions of the first media data (214a and 214b, respectively) and the second and third portions of the second media data (216a and 216b, respectively) in one particular example.

In one example, these second (214a, 216a) and third portions (214b, 216b) of first and second media data (202 and 204, respectively) can include alternative conclusions to each of the respective first and second media data (202 and 204). In other words, at a point in time (as shown, for example, in FIGS. 2A, 2B, and 2C) as the second selection of media data 212, an end-user can select which of the alternative endings she wishes to choose. For example, if the end-user is viewing the first media data 202 at a point in time when the second selection of media data 212 occurs, she can be given the opportunity of selecting one of the second portion of first media data 214a or the third portion of first media data 214b.

Conversely, if the end-user is viewing the second media data 204 at a point in time when the second selection of media data 212 occurs, she can be given the opportunity of selecting one of the second portion of second media data 216a or the third portion of first media data 216b. In other words, second 214a and third 214b portions of the first media data 202 can include first and second alternative endings, respectively, among the plurality of alternative endings of the first media data 202 and the second 216a and third 216b portions of the second media data 204 can include first and second alternative ending, respectively, among the plurality of alternative endings of the second media data 204.

Each of the alternative conclusions (e.g., 214a and 214b) can occur in parallel with respect to one another throughout time. In other words, if first media data 202 involves a story relating to a first character, second portion of first media data 214a can involve a scenario where the first character lives, whereas third portion of first media data 214b can involve a scenario where the first character dies. By offering this second selection of media data 212, an end-user has the opportunity to dynamically select the fate of the character and/or the conclusion of the particular media data being viewed. An example of how this may occur is described below in greater detail with reference to the method for displaying media content as described in FIG. 1.

With specific reference to FIG. 1, the process 100 can begin with the step 102 of providing a first selection of the media content. This step can include an end-user selecting either first media data 202 or second media data 204. In an exemplary and non-limiting illustrative embodiment, the step 102 of providing a first selection can first begin by outputting an introduction screen (e.g., a splash screen or the like) that can include graphics or the like related to the media to be displayed. For example, if the media content includes a music video, the band's logo, the name of the song, and/or the characters involved in the video can be displayed in a variety of manners (e.g., fading in and out, sliding in from an end of the display, etc.).

At this point, the end-user can be given the opportunity to select a particular story and/or character included within in one of the first or second media data. This selection can be performed through a menu-type interface (such as, for example, a GUI interface with a mouse), or through a touch-screen type interface. The menu can further include instructions for making a selection (such as text indicating that the end-user should “Choose your side”). The selection can be made by the end-user selecting a button, icon, or the like of the character or story that she wishes to choose. In one example, the first media data can include the story of a hit man and the second media data can include the story of a law enforcement officer.

Once the selection is made, the step 104 of outputting a first portion of the selected first or second media data can occur. For example, once the step 104 of outputting a first portion of the first or second media data begins, a new screen can be displayed that is responsible for the playback of the media content and the end-user's interactivity with it. For example, the end-user can be provided with two options: “Back” and “Switch,” although other options are contemplated as well. These options can include buttons, icons, etc. that can be selected either through a touch-based interface or through other known means for advancing through GUI menu interfaces.

In this example, the “Back” option can terminate the outputting step 104 and return the end-user back to the introduction screen and the process described above can repeat. The “Switch” option can allow the end-user to switch, on-the-fly and synchronized with the media playback, from the first media data to the second media data or vice-versa. This process is described in greater detail below with reference to the step 110 of providing at least one transition opportunity. As explained below, these transition opportunities can occur at any point that the end-user has the option to select the “Switch” option as described above (which can occur continuously throughout the playback of the first portion of the first or second media data (206 and 208, respectively), or at discrete time intervals (either uniformly, or non-uniformly throughout time).

Of course, in the absence of a selection, the process can continue with a default selection for the end-user either by a determined algorithm and/or by random selection. The step 104 of outputting a first portion can include beginning to output and/or display the selected first portion of media data at a given point in time (typically, the beginning of the selected media data) and continuing to output and/or display the selected media until a transition opportunity occurs (e.g., 210a, 201b, 210c, . . . , 210g, and so on) and/or the step of providing a second selection of media content occurs.

The step 106 of providing a second selection of media content can occur at a point in time at the conclusion of the first portion of the first and second media data (202 and 204, respectively). This step can begin by removing the “Switch” and “Back” buttons described above and a similar-type menu can be employed so that the end-user is presented with two or more options for ending the media data (e.g., “Ending” menu). For example, if there are two alternative endings, the user can select a menu and/or button for which ending she wishes to view.

At this point in time, the step 106 can include providing a selection of the second 214a and third 214b portions of the first media data 202 if the first media data 202 is outputting at a point in time when providing a second selection of the media content step 106 occurs or providing a selection of the second 216a and third 216b portions of second media data 204 if the second media data 204 is outputting at a point in time when providing a second selection of the media content step 106 occurs.

At this point, the end-user can make his selection, or in the alternative, a default selection can be made for the end-user (either through an algorithm or selected randomly). Once the selection is made, the step 108 of outputting a selected portion of the second or third portions of media data can occur. In this step, the selected portion is outputted and/or displayed to the end-user throughout to the conclusion of the first or second media content. It is important to note that the determination of whether an end-user can select between the second 214a or third 214b portions of the first media data or between the second 216a or third 216b portions of the second media data can be dependent upon which of the media data (e.g., first 202, or second 204) is being displayed at the point in time when the step 106.

The step of providing at least one transition opportunity 110 can include providing an end-user with an opportunity to select the other of the first or second media data at some point in time prior to the step 106 of providing a second selection of the media content. In other words, if the end-user, at step 102 of providing a first selection of media content, selects the first media data 202, the end-user would have an opportunity to switch to the second media data 204 at the point in time where the step 110 of providing at least one transition opportunity occurred. This allows the end-user to discontinue following and/or viewing the originally selected media data in favor of the other, non-selected, media data.

The “Switch” operation can be performed on-the-fly such that that the end-user can switch between the media content seamlessly. In order to do so, the media content 200 (as illustrated, for example, in FIG. 2A), can be recorded and/or stored as one continuous string of data. For example, FIG. 2C illustrates media content 200 stored in one contiguous memory location (e.g., between bits 00000000-11111111). It is important to note that the illustrated eight-bit memory location is merely illustrative and other memory sizes and/or addressing schemes are contemplated as well. Furthermore, one or more of the described blocks can be spread across non-contiguous memory locations equally as well.

As illustrated in FIG. 2C, pointers (illustrated by the various arrows throughout the figure) can be employed to skip between and among various memory locations throughout the outputting, displaying, and/or playback of the media content. For example, if the end-user begins with the first portion of the first media data 206, this portion can output starting at t₀. At t₃, in this example, the end-user has a transition opportunity 210a. If the end-user elects to transition from the first portion of the first media data 206 to the first portion of the second media data 208, the end-user can select the “Switch” button described above and the pointer shown in the figure can be employed to skip to t₃ for the first portion of the second media data 208, and so on. When the end of portion is reached (e.g., t₂₀ as shown here), the end-user can encounter the second selection of media data 212 and can be required to select either the second or third portions of the media data. Once selected, that selection portion can continue to be outputted to its conclusion (represented here as t₄₀).

It is important to note that the time increments chosen for this example are merely illustrative and non-limiting. Greater and less granularity may be employed for each time increment (e.g., t₀-t₂₀ for a first portion can be replaced with t₀-t₄₀ for the same amount of time elapsed between these two segments). Furthermore, each portion (e.g., first, second, and third) can be equal size and/or duration (as shown in FIG. 2C), or different sizes and/or durations with respect to one another. Finally, each time increment (e.g., t₀, t₁, t₂, etc.) can be uniformly defined in time (i.e., each segment equals a certain constant amount of time) or, in the alternative, the increments can vary in the amount of time they each define among each other. Additionally, although each portion is shown in this figure as including separation (i.e., empty memory) from the end of one portion (e.g., 206) to the next (e.g., 208), in other examples, these can be stored contiguously (e.g., portion 206 can end at memory location 00001111 and portion 208 beings at memory location 00010000).

Because the timing for each portion can be tracked throughout the playback/output of any given portion of the media content 200, every frame of output can be monitored to ensure a seamless transition from one portion to another. In the example shown in FIG. 2C, this transition can be instantaneous. In another example (not shown in FIG. 2C) of the “Switch” function (e.g., transition opportunities 210), the time (tₓ) in which the end-user elects to switch between the first portions of the first and second media data can be stored as a variable to ensure the output continues for the newly elected first portion. The variable can then be added to a constant, such as an offset, as described in greater detail below.

For example, if the end-user elects to switch at time t₃, the variable can be set to t₃ and added to the offset to account for any decoding delay. By using this offset, the newly selected media data can start at a location beyond the location where the end-user selected to switch between portions of the media data, equal to the offset. In this example, if the offset is an extra 0.8 seconds, the newly selected portion can begin 0.8 seconds after t₃ in order to allow for a smoother transition from one portion to the other (e.g., fading out the originally selected portion and fading in the newly selected portion). Furthermore, the point in time (e.g., time increment) when the first portion concludes (as shown in the example of FIG. 2C as t₂₀) can be monitored such that once that time increment is reached, the “Switch” option described above can be replaced with the “Ending” menu described above so that the end-user can select which ending to view (which, as shown in FIG. 2C, would begin at t₂₁ and conclude at t₄₀). Once this ending concludes (t₄₀ for this example), the end-user can be returned to the introduction screen and the process described above can repeat, allowing the end-user to select between the first portion of the first media data 206 or the first portion of the second media data 208.

In the example of a music video or other video that incorporates music (such as a movie), the audio track or tracks can be recorded separately so that the switching between portions of the media content will not affect the audio playback and, therefore, can enhance the end-user's playback experience without any glitches in the audio playback.

Returning to FIG. 1, in one example, the step 110 of providing at least one transition opportunity can occur continuously throughout the step 104 of outputting of the first portion of the selected media data. In other examples, the step 110 of providing at least one transition opportunity can occur at regular or irregular discrete time interviews through the step 104 of outputting of the first portion of the selected media data (e.g., every few seconds, or at a commonality point between first and second sub-plots). In the example where the step 110 of providing at least one transition opportunity occurs only at a commonality point, the end-user would have to wait until the outputted selected media data displays the interaction and/or intertwining of the first and second media data's (202 and 204, respectively) characters and/or sub-plots.

In this embodiment, an end-user would be able to transition from the selected media data to the non-selected media data in a seamless manner (e.g., following a first character until he meets the second character at a point of time in the music video and subsequently following the second character in favor of the first). In other words, the at least one transition opportunity provides an opportunity to output a portion of the second media data if the first portion of the first media data is being outputted or output a portion of the first media data if the first portion of the second media data is being outputted.

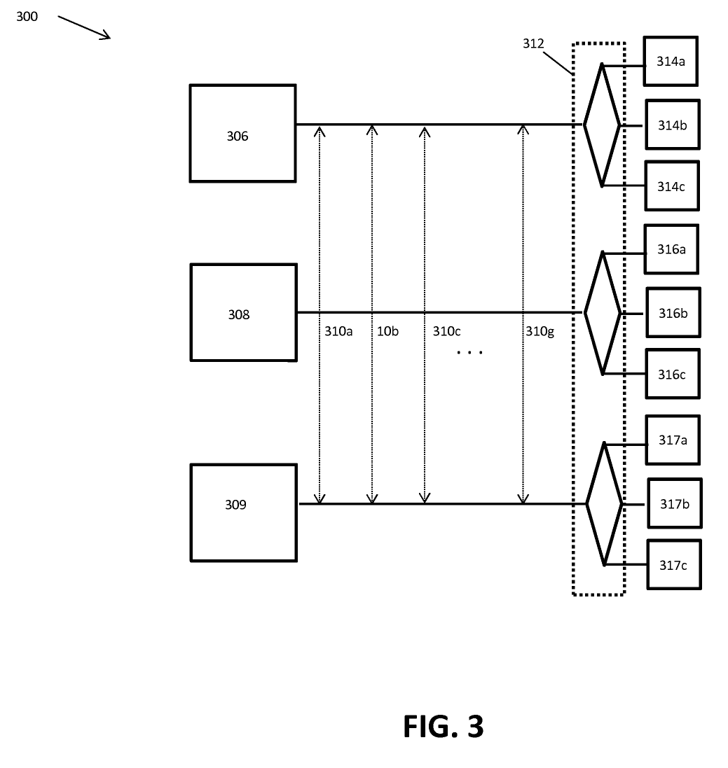

Although the example used above describes media content 200 as being a music video, the inventions described herein can be applied to other examples of content (such as movies, songs, etc.) equally as well. Furthermore, the number portions of media data, and the number of media data can vary as well (as illustrated, for example in greater detail below with reference to FIG. 3). Finally, although only one step 106 of providing a second selection of the media content is illustrated with reference to FIGS. 1-2C, more than one of these selections can be implemented such that an end-user can select among multiple outcomes for a given media data before reaching the final selection (as presently illustrated in FIGS. 2A, 2B, and 2C as the second selection of media data 212). In order to further describe the inventions as set forth above, two particular, non-limiting examples are provided in FIGS. 2D and 2E, below.

FIG. 2D is a first embodiment of a functional block diagram illustrating an exemplary chosen path in accordance with certain aspects of the inventions described herein. FIG. 2E is a second embodiment of a functional block diagram illustrating an exemplary chosen path in accordance with certain aspects of the inventions described herein. These figures will be described in conjunction with one another.

Referring specifically to FIG. 2D, an end-user is provided with a first selection of the media content 200 (FIG. 1, step 102) (i.e., either the first portion of the first media data 206 or the first portion of the second media data 208). In this example, the end-user selected the first portion of the first media data (as illustrated by the dashed line). As the first portion of the selected first media data is outputted (FIG. 1, step 104) is being performed, the end-user is provided with at least one transition opportunity (FIG. 1, step 110) at point in time reflected by the double arrow (210a). In this example, the end-user has elected to not avail himself of the transition opportunity at transition opportunity 210a.

Moving forward in time (i.e., moving left to right along the dashed line as depicted in these figures), the end-user, when presented with a second transition opportunity 210b, has elected to switch from the first portion of the first media data 206 to the first portion of the second media data 208. Once this switch occurs, the first portion of the second media data 208 is outputted and/or displayed in lieu of the first portion of the first media data 206 that was outputted and/or displayed prior to the end-user's election to switch.

Subsequently, the end-user is presented with multiple additional opportunities to switch back to his original selection of the first portion of the first media data 206. At transition opportunity 210g, the end-user elects to switch back to the first portion of the first media data 206. It is worthy to note that in this particular example, transition opportunity 210g is the final opportunity offered to the end-user to switch between the first portions of the first and second media data (206 and 208, respectively). That is, once the first portion of selected media data reaches the point in time of the second selection of media data 212, the end-user must choose between at least two alternative endings for the media data that was being outputted and/or displayed at that particular time. In this example, the first portion of the first media data 206 was being outputted at this point in time and, therefore, the end-user can select between the second portion of the first media data 214a or the third portion of the first media data 214b. In this example, the end-user has selected second portion 214a.

Typically, the conclusion of the first portion of the first media data 206 and the conclusion of the first portion of the second media data 208 occur at the same point in time as the second selection of the media data 212. In other words, once the second selection 212 is offered to the end-user, the first portion of the media terminates. In this example, the media data can not continue until the end-user makes his selection or the selection is made by default. Only after the selection occurs, can the selected media continue to output (e.g., FIG. 1, step 108). Alternatively, the first portion of the media can continue to be outputted for a period of time while the end-user has the option to elect either the second or third portions of the media data.

Referring specifically to FIG. 2E, in this example, the end-user has initially selected the first portion of the second media data 208 and has further elected to not switch to the first portion of the first media data 206. At the point in time that the second selection of media data 212 occurs, the end-user elected the third portion of the second media data 216b. Although not shown in these figures, alternatively the end-user can select either the second or the third portions of the media data for which is not presently being outputted at the point in time when the second selection of media data 212 occurs. In other words, using the example illustrated in FIG. 2E, the end-user would have the ability to elect to view either of the second or third portions of media data (e.g., 214a, 214b, 216a, or 216b). Additionally, in other examples, the end-user can elect to output more than one of the second or third portions of the media data (either in parallel (e.g., split screen) or sequentially). Note, the output of other portions of the media content (e.g., first portions of first and second media data) can similarly be output such that more than one portion is output (i.e., parallel (e.g., split screen) or sequentially).

FIG. 3 is an alternative embodiment of a functional block diagram in accordance with certain aspects of the inventions described herein. For FIG. 3, many, but not all, of the illustrated features of the described inventions share features with the embodiments described in FIGS. 2A-2E, above. For example, referring specifically to FIG. 3, the media content 300 illustrated in this figure shares many common elements with the media content 200 illustrated in FIGS. 2A-2E (e.g., first portion of the media data 206, second portion of the second media data 216a, etc.). All of these features are described in detail with reference to FIGS. 2A-2E and thus, in the interest of clarity and brevity, will not be repeated for the description for FIG. 3.

Moreover, several features described with reference to FIGS. 2A-2E are illustrated in FIG. 3, but not specifically labeled for this embodiment. One of ordinary skill in the art, therefore, would understand that similar features illustrated in FIG. 3 share common features, descriptions, embodiments as those features illustrated and described with reference to FIGS. 2A-2E. Although the portions of the disclosure describing FIG. 3 mainly focus on the differences of those elements previously described with reference to FIGS. 2A-2E, one of ordinary skill in the art would recognize that one or more of the elements described in reference to FIG. 3 can be similarly embodied, where appropriate, as those elements described in reference to FIGS. 2A-2E.

Turning now to FIG. 3, media content 300 can include a first portion of first media data 306, a first portion of second media data 308, and a first portion of third media data 309. Furthermore, media content 300 can include a second (314a, 316a, 317a), third (314b, 316b, 317b), and fourth (314c, 316c, 317c) portions of first, second, and third media data, respectively. FIG. 3 similarly can include one or more transition opportunities (310a-310g) and the second selection of media data 212.

It is important to note that although only seven transition opportunities are disclosed (e.g., 310a-310g), a greater or fewer number of such transition opportunities can be employed as well. Similarly, although only a single second selection of media data 312 is illustrated by this example, more than one of such selection points can be employed as well. Additionally, though three media data choices are presented in this example (e.g., 306, 308, and 309) and three alternative conclusions are illustrated for each media data (e.g., 314a, 314b, and 314c for the first media data 306), these two do not necessarily need to be equal as illustrated in this example. If the number of media data choices is represented by the number “n” (in this example, three) and the number of alternative conclusions is represented by the number “m” (in this example, again, three), n≧2 (for integer values of n) and m≧2 (for integer values of m).

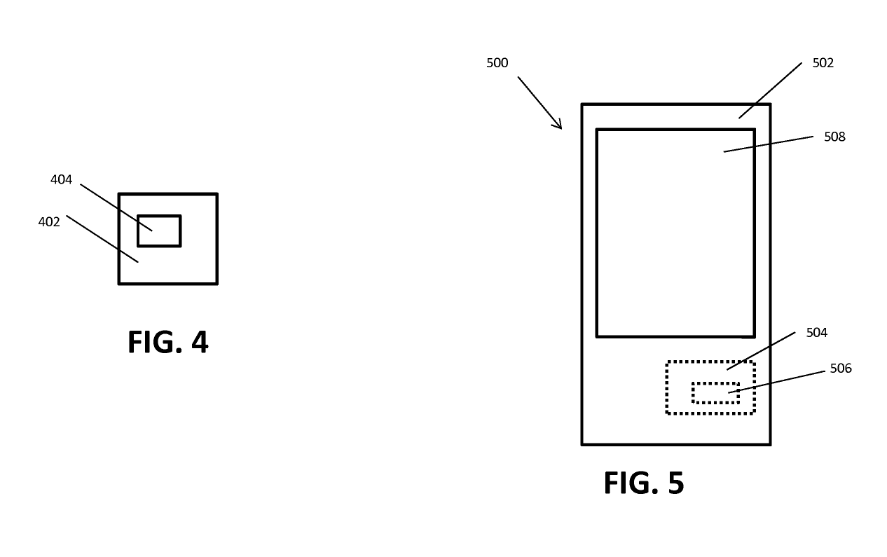

FIG. 4 illustrates an embodiment of a computer readable medium configured to store an application for displaying custom-tailored music video content in accordance with certain aspects of the inventions described herein.

Computer readable medium 402 can include any medium that that can be used in conjunction with the computer readable instructions, programs, or applications, such as, for example, the applications and/or programs described in conjunction with the process steps described in greater detail herein. For example, computer readable medium 402 can be configured to store an application 404 for displaying media content and the application 404 can be adapted to execute instructions for displaying media content. Application 404 can include programs, firmware, software, hardware, or any combination thereof for instructing a computer or other electronic device for performing and/or carrying out a series of steps and/or instructions in accordance with the process steps described above (such as, for example, FIG. 1).

The computer readable instructions can include any code and/or instruction that is adapted to be read by a computer, such as, assembly, machine, executable, non-executable, compiled, or uncompiled code, or any other instructions adapted to be read by a computer or electric device with an arithmetic logic unit.

In an exemplary and non-limiting illustrative embodiment, the computer readable medium 402 can include a computer readable storage medium (“CRSM”). The computer readable storage medium can take many forms, including, but not limited to, non-volatile media and volatile media, floppy disks, flexible disks, hard disks, magnetic tape, other magnetic media, CD-ROMs, DVDs, or any other optical storage medium. Computer readable storage media can further include RAM, PROM, EPROM, EEPROM, FLASH, combinations thereof (e.g., PROM EPROM), or any other memory chip or cartridge.

The computer readable medium 402 can further include computer readable transmission media (“CRTM”). These transmission media can include coaxial cables, copper wire and fiber optics. Transmission media may also take the form of acoustic or light waves, such as those generated during radio frequency, infrared, wireless, or other media comprising electric, magnetic, or electromagnetic waves.

FIG. 5 illustrates an embodiment of a system for displaying custom-tailored music video content in accordance with certain aspects of the inventions described herein. It is important to note that several features described with reference to FIG. 4 are similarly illustrated in FIG. 5 (e.g., computer readable memory 402 in FIG. 4 and computer readable medium 502 in FIG. 5). As such, the examples and embodiments for those elements described with reference to FIG. 4 can similarly describe examples and embodiments for those corresponding elements in FIG. 5.

System 500 can include a mobile device 502, a computer readable medium 504, application 506, and display unit 508. Mobile device 502 can include any type of mobile device adapted display media content. In an exemplary and non-limiting illustrative embodiment, the mobile device 502 can be a handheld cellular phone, such as an APPLE® iPhone®. The mobile device 502 can further include any cellular phone, such as a BlackBerry® device, or any other portable device such as a PDA, a tablet (for example, an APPLE® iPad or iMac®), mp3 player, or electronic reader. Furthermore, the mobile device 502 can be a computer, such as a laptop, netbook, or notebook device or any mobile device capable of displaying media content. Alternatively, mobile device 502 can be replaced with an electronic device (not shown), such as a computer that is not typically considered mobile, such as a desktop computer or other non-portable electronic device adapted to display media content.

In one example, computer readable medium 504 can include a storage medium, such as a hard disk drive or FLASH memory drive of a cellular phone. In another example, computer readable medium 504 can be located distally and/or remotely from the mobile device 502 (e.g., on a server) such that the data, media, and/or instructions stored on it can be transmitted to the mobile device 502 so that it can display the media content.

In an exemplary and non-limiting illustrative embodiment, mobile device can include an APPLE® iPhone® and the computer readable medium 504 can include the memory native to the cellular phone. In this example, application 506 can include a software application, such as an “app” for an APPLE® iPhone®. Moreover, in keeping with this particular example, an end-user can load the application 506 by downloading the program from a service such as APPLE® iTunes, or the APPLE® App Store, or in the alternative, the application 506 can be integrated in the operating system native to the particular mobile device 502 such that when the application 506 executes instructions, it can perform the steps as described, for example, in conjunction with FIG. 1. The application 506 can further include links (such as buttons, icons, or the like) to social media sites such as FACEBOOK® and TWITTER® such that the application 506, its content, and/or the end-users' selections can be shared through social media.

In one particular example, application 506 can be programmed with a lower-level framework, for example, AVFoundation, that allows the use of individual assets and greater control of manipulating them on-the-fly. This particular framework further allows for seeking tolerance and, thus, when a user performs an action that requires movement to a different location within a memory (e.g., playhead) within the media, the application 506 can seek to that location with a set tolerance before and after to ensure a strong synchronicity with an associated audio track. This tolerance can allow a little leeway based on hardware constraints that could cause decoding delays of the compressed media. If no tolerance were allowed, there could be a delay in the user interactivity while the application 506 decodes the newly selected media data and a noticeable glitch could appear that could adversely affect the end-user's viewing experience. By combining these tolerances and/or offsets with proper editing techniques, these undesirable glitches can be minimized or even eliminated altogether to provide a clean, interactive experience.

Additionally, application 506 can include an interrupt feature. With the interrupt feature, outputting and/or displaying of the media content can be paused if another application, portion or the operating system, etc. attempts to utilize one or more common resources. For example, if mobile device 502 is a cellular phone, the interrupt feature can active when someone attempts to call the mobile device 502. In this example, end-user could have the options to either take the call, or ignore it and continue viewing the playback of the media data.

Display unit 508 can include televisions (such as LED, LCD, plasma, etc.), monitors, projector screens, and/or any other display device for outputting data, pictures, videos, graphic, or the like. For example, display unit 508 can include any device adapted to convey, project, output, and/or display data or information received from an electronic device. In an exemplary and non-limiting illustrative embodiment, display unit 508 can include the display screen of a cellular phone. In this example, end-user inputs can be received through a touch-screen interface with the cellular phone. Finally, display unit 508 can include a surface, such as wall—for which video can be displayed upon—that is adapted to convey the projected data, image, or the like to an end-user.

Although not explicitly recited throughout the description related to the process steps set forth in FIG. 1, certain aspects of the inventions that are described in conjunction with the apparatuses and systems above (such as, for example, a particular function of element) can be carried out as one or more process steps and/or instructions adapted to executed those one or more process steps.

The figures described above and the written description of specific structures and functions below are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment.

Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the invention or the appended claims.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Computer programs for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package.

Other and further embodiments utilizing one or more aspects of the inventions described above can be devised without departing from the spirit of Applicant's invention. It should be appreciated by those of skill in the art that the techniques disclosed in the disclosed embodiments represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention. Other variations of the systems, apparatuses, and methods can be included in combination with each other to produce variations of the disclosed embodiments. Discussion of singular elements can include plural elements and vice-versa.

In some alternate implementations, the functions/actions/structures noted in the figures can occur out of the order noted in the block diagrams and/or operational illustrations. For example, two operations shown as occurring in succession, in fact, can be executed substantially concurrently or the operations can be executed in the reverse order, depending upon the functionality/acts/structure involved.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicant intends to fully protect all such modifications and improvements that come within the scope or range of equivalent of the following claims.

What is claimed is:

1. A method for displaying media content, the method comprising the steps of:
providing a first selection of the media content, wherein the media content comprises first media data and second media data;
outputting a first portion the first media data if the first media data is selected or a first portion of the second media data if the second media data is selected;
providing a second selection of the media content, wherein the media content for selection comprises second and third portions of the first media data and second and third portions of the second media data; and;
outputting a selected portion of the media content among the second and third portions of the first and second media data.

2. The method according to claim 1 further comprising the step of providing at least one transition opportunity, wherein the at least one transition opportunity is provided before the step of providing a second selection of the media content begins.

3. The method according to claim 2, wherein the at least one transition opportunity provides an opportunity to output a portion of the second media data if the first portion of the first media data is being outputted or output a portion of the first media data if the first portion of the second media data is being outputted.

4. The method according to claim 1 wherein the step of providing a second selection further comprises:
(i) providing a selection of the second and third portions of the first media data if the first media data is outputting at a point in time when providing a second selection of the media content step occurs or
(ii) providing a selection of the second and third portions of second media data if the second media data is outputting at a point in time when providing a second selection of the media content step occurs

5. The method according to claim 1 wherein the media content comprises a music video comprising a plurality of alternative endings.

6. The method according to claim 5 wherein the second and third portions of the first media data includes first and second alternative endings, respectively, among the plurality of alternative endings of the first media data and the second and third portions of the second media data includes first and second alternative ending, respectively, among the plurality of alternative endings of the second media data.

7. The method according to claim 1 wherein the first media data comprises a first sub-plot of the music video and the second media data comprises a second sub-plot of the music video.

8. The method according to claim 7 wherein the first sub-plot comprises a first character and the second sub-plot comprises a second character.

9. The method according to claim 8 wherein the step of providing at least one transition opportunity is performed at a commonality point between the first and second sub-plots.

10. The method according to claim 9 wherein the commonality point comprises a music video frame comprising both the first and second characters.

11. A computer readable medium configured to store an application for displaying media content, wherein the application is adapted to execute instructions, comprising:
providing a first selection of the media content, wherein the media content comprises first media data and second media data;
outputting a first portion the first media data if the first media data is selected or a first portion of the second media data if the second media data is selected;
providing a second selection of the media content, wherein the media content for selection comprises second and third portions of the first media data and second and third portions of the second media data; and;
outputting a selected portion of the media content among the second and third portions of the first and second media data.

12. The computer readable medium according to claim 11 wherein the application is adapted to execute instructions further comprising the step of providing at least one transition opportunity, wherein the at least one transition opportunity is provided before the step of providing a second selection of the media content begins.

13. The computer readable medium according to claim 12, wherein the at least one transition opportunity provides an opportunity to output a portion of the second media data if the first portion of the first media data is being outputted or output a portion of the first media data if the first portion of the second media data is being outputted.

14. The computer readable medium according to claim 11 wherein the step of providing a second selection further comprises:
(i) providing a selection of the second and third portions of the first media data if the first media data is outputting at a point in time when providing a second selection of the media content step occurs or
(ii) providing a selection of the second and third portions of second media data if the second media data is outputting at a point in time when providing a second selection of the media content step occurs

15. The computer readable medium according to claim 11 wherein the media content comprises a music video comprising a plurality of alternative endings.

16. The computer readable medium according to claim 15 wherein the second and third portions of the first media data includes first and second alternative endings, respectively, among the plurality of alternative endings of the first media data and the second and third portions of the second media data includes first and second alternative ending, respectively, among the plurality of alternative endings of the second media data.

17. The computer readable medium according to claim 11 wherein the first media data comprises a first sub-plot of the music video and the second media data comprises a second sub-plot of the music video.

18. The computer readable medium according to claim 17 wherein the first sub-plot comprises a first character and the second sub-plot comprises a second character.

19. The computer readable medium according to claim 18 wherein the step of providing at least one transition opportunity is performed at a commonality point between the first and second sub-plots.

20. A system for displaying media content, wherein the system comprises:
a mobile device; and
a computer readable medium configured to store an application for displaying media content, wherein the application is adapted to execute instructions, comprising:
providing a first selection of the media content, wherein the media content comprises first media data and second media data;
outputting a first portion the first media data if the first media data is selected or a first portion of the second media data if the second media data is selected;
providing a second selection of the media content, wherein the media content for selection comprises second and third portions of the first media data and second and third portions of the second media data; and;
outputting a selected portion of the media content among the second and third portions of the first and second media data.
